(19) United States
(12) Patent Application Publication
(10) Pub. No.: US 2025/0378805 A1
(43) Pub. Date: Dec. 11, 2025

(54) STRINGLESS GUITAR

(71) Applicant: HUIZHOU ENYA MUSICAL INSTRUMENT CO., LTD., HUIZHOU (CN)

(72) Inventor: HAIMING HU, HUIZHOU (CN)

(21) Appl. No.: 19/266,460

(22) Filed: Jul. 11, 2025

Related U.S. Application Data
(63) Continuation of application No. PCT/CN2024/123990, filed on Oct. 10, 2024.

(30) Foreign Application Priority Data
Jun. 6, 2024 (CN) 202421297741.6
Jun. 6, 2024 (CN) 202421299488.8
Jun. 6, 2024 (CN) 202421299744.3
Jun. 25, 2024 (CN) 202421467321.8

(51) Int. Cl. G10H 1/00; G10H 1/34

(52) U.S. Cl. CPC G10H 1/0016; G10H 1/34; G10H 2230/145

(57) ABSTRACT

A stringless guitar includes a guitar body, a guitar neck connected to the guitar body, a keyboard, a chord board, a tuning device disposed on the guitar neck, a light indication system, a speaker, and a rotating folding support structure. The keyboard and the speaker are respectively disposed in a first mounting space and a second mounting space of the guitar body. The tuning device includes a rocker and a sensor. One end of the rocker is connected to the sensor. The other end of the rocker extends out of the guitar neck. The light indication system includes a first indicator light configured to indicate playing positions on the keyboard and a second indicator light configured to indicate playing positions on the chord board. The rotating folding support structure is mounted on the guitar body to prevent the guitar body from sliding off legs of a player.

### TECHNICAL FIELD

The present disclosure relates to a technical field of musical instruments, and in particular to a stringless guitar.

### BACKGROUND

A stringless guitar is an innovative form of an innovative electronic musical instrument that omits physical strings required by a classical guitar and instead uses advanced sensing technology and electronic devices to simulate or generate musical sounds. The stringless guitar not only retains an appearance and some operating methods of the classical guitar, but also integrates touch sensors or other electronic sensors to accurately detect positions and movements of fingers of a player. The innovative features of the stringless guitar allow the player to trigger different notes through finger operations like playing the classical guitar, while further allowing the player to create rich sound effects and musical styles by the stringless guitar. However, the stringless guitar in the prior art still has certain limitations in terms of portability, playing stability, versatility, and convenience of tone adjustment.

First, the stringless guitar is easy to slip off legs of the player during the performance, affecting a performing effect. Second, the stringless guitar in the prior art lacks a variety of playing methods, and it is difficult to conveniently adjust the tone and timbre during the performance to adapt to different musical styles and occasions, thus limiting creative freedom of the player. Finally, a toning device of the stringless guitar is commonly disposed on a guitar body, which is easy to affect the performance due to accidental contact. Further, it is not easy to quickly adjust the toning device during the performance.

In view of problems in the prior art, how to design a stringless guitar that is convenient to carry, has various playing methods, and is easy to adjust the tone and timbre during the performance has become an important issue in a field of musical instrument manufacturing. In response to the problems in the prior art, the present disclosure proposes a stringless guitar, which aims to solve shortcomings of the stringless guitar in the prior art in terms of portability and functionality, so as to enhance a playing experience and the creative freedom of the player.

### SUMMARY

To solve problems in the prior art, the present disclosure proposes a stringless guitar, which aims to solve shortcomings of a stringless guitar in the prior art in terms of portability and functionality, so as to enhance a playing experience and creative freedom of a player.

The present disclosure provides the stringless guitar. The stringless guitar comprises a keyboard, a speaker, a guitar body, a chord board, a guitar neck, a tuning device, a light indication system, and a rotating folding support structure.

The guitar body is a box structure. The keyboard is disposed in a first mounting space of the guitar body. The speaker is mounted in a second mounting space of the guitar body. The guitar neck is connected to the guitar body.

The chord board is bar-shaped and is mounted on the guitar neck. The tuning device is disposed on one end of the guitar neck away from the guitar body. The tuning device comprises a rocker and a sensor. A first end of the rocker is connected to the sensor, a second end of the rocker extends out of a side surface of the guitar neck, and the second end of the rocker is configured for a player to operate. The light indication system comprises a first indicator light and a second indicator light. The first indicator light is configured to indicate playing positions on the keyboard. The second indicator light is configured to indicate playing positions on the chord board. The rotating folding support structure is mounted on the guitar body and is configured to prevent the guitar body from sliding off legs of the player.

Furthermore, a main control board is disposed in the guitar body. The keyboard, the chord board, the toning device and the speaker are connected to the main control board. The main control board is configured to receive signals from the keyboard and the chord board and control the speaker to output a corresponding melody.

Furthermore, the guitar body is a triangular box structure. The guitar body comprises a first box and a second box. A keyboard fixing piece configured to fix the keyboard is disposed on the second box. A contact sheet of the main control board is connected to the keyboard through a through hole defined on the second box. An adapter is disposed in one end of the guitar body close to the chord board. The adapter is connected to the main control board and the chord board.

Furthermore, the keyboard comprises a keyboard box. A clamping groove is defined on a bottom portion of the keyboard box. The keyboard fixing piece is engaged with the clamping groove.

A control board is disposed inside the keyboard box. The control board comprises contact points. The contact points are connected to the contact sheet of the main control board through an opening on the keyboard box, so that the control board is communicated with the main control board.

Furthermore, a silicone pad and keys are disposed on the control board. An L-shaped light guide strip is disposed on the keys. The L-shaped light guide strip is clamped in the keys through a bending rack. The first indicator light is connected to the keyboard box through a support. Light sheets are disposed on the light guide strip. When one of the keys is pressed, a corresponding one of the light sheets is controlled to emit light.

Furthermore, the chord board comprises an upper cover board and a fretboard, the upper cover board is mounted on the guitar neck to jointly define a chamber. The second indicator light and a mounting bracket are mounted in the chamber. The fretboard is disposed on the upper cover board. Patches are disposed on the fretboard, and the patches are connected to the second indicator light through the adapter and the mounting bracket. The patches and the second indicator light are communicated with the main control board and are controlled by the main control board.

Furthermore, light guide columns are embedded in the fretboard. The light guide columns are connected to the second indicator light. Light strips are disposed on the second indicator light. The light strips are one-to-one corresponding to the light guide columns.

Furthermore, the rotating folding support structure comprises a lower bracket, an upper bracket, and a rotating shaft. The lower bracket is fixed to a middle portion of the guitar body. The lower bracket is an arc-shaped structure and is configured to support on the legs of the player. The rotating shaft is mounted on a bottom portion of the guitar body. Two ends of the upper bracket are respectively rotatably connected to the guitar body and the rotating shaft.

The present disclosure not only solves problems of conventional stringless guitars, such as inconvenient portability, poor playing stability, and single function, but also greatly improves the playing experience and the creative freedom of the player by introducing functions such as light indication and tone adjustment, thereby providing the player with diverse convenient playing methods.

Specifically, the stringless guitar improves the playing stability of the player. The stringless guitar introduces the rotating folding support structure. The rotating folding support structure comprises the lower bracket and the upper bracket, which allows the stringless guitar to be placed firmly on the legs of the player, effectively preventing the stringless guitar from slipping off and improving the stability and comfort during playing.

The stringless guitar is able to be played in a variety of ways. The stringless guitar comprises the keyboard and the chord board, so the stringless guitar has a variety of playing methods. The stringless guitars not only retains the playing characteristics of a classical guitar, but also introduces functions of modern electronic instruments, thereby enriching the playing experience of the player and allowing the player to flexibly choose different suitable playing methods according to different music styles and occasions.

The tuning of the stringless guitar is very convenient. The tuning device is disposed on the second end of the guitar neck away from the guitar body, and the tuning device is designed as the rocker, which is convenient for the player to switch the tone during the performance or in an interval, avoiding a problem of accidental touch caused by disposing the tuning device on the guitar body.

Light indication of the stringless guitar enhances a performance effect. In the light indication system, the first indicator light and the second indicator light are configured to indicate performance positions on the keyboard and the chord board respectively, so that the player is allowed to more intuitively understand positions corresponding to notes to be played, thereby improving accuracy and efficiency of the performance.

The stringless guitar provides playing prompts and feedback. The L-shaped light guide strip and the light sheets are disposed in the keyboard, and the light guide columns and the light strips are disposed in the chord board. Light prompts help the player to play the stringless guitar more accurately and enhance the playing experience.

### BRIEF DESCRIPTION OF DRAWINGS

In order to clearly describe technical solutions in the embodiments of the present disclosure, the following will briefly introduce the drawings that need to be used in the description of the embodiments or the prior art. Apparently, the drawings in the following description are merely some of the embodiments of the present disclosure, and those skilled in the art are able to obtain other drawings according to the drawings without contributing any inventive labor.

FIG. 1 is a schematic diagram of a stringless guitar according to one embodiment of the present disclosure.

FIG. 2 is a schematic diagram of a guitar body assembled with a rotating folding support structure according to one embodiment of the present disclosure.

FIG. 3 is an exploded schematic diagram of the guitar body assembled with the rotating folding support structure shown in FIG. 2.

FIG. 4 is another schematic diagram of the stringless guitar according to one embodiment of the present disclosure.

FIG. 5 is n exploded schematic diagram of the stringless guitar according to one embodiment of the present disclosure.

FIG. 6 is a partial schematic diagram of a keyboard according to one embodiment of the present disclosure.

FIG. 7 is a partial schematic diagram of a chord board according to one embodiment of the present disclosure.

In the drawings: 1—guitar body; 11—first box body; 12—second box body; 13—second mounting space; 14—first mounting space; 16—keyboard fixing piece; 17—adapter; 18—main control board; 19—contact sheet; 2—guitar neck; 3—keyboard; 31—keyboard box; 311—clamping groove; 32—control board; 33—contact points; 34—silicone pad; 35—key; 36—bending rack; 37-L—shaped light guide strip; 38—support; 39—first indicator light; 4—chord board; 41—upper cover board; 42—chamber; 43—second indicator light; 44—fretboard; 45—light guide column; 5—toning device; 51—rocker; 52—sensor; 6—speaker; 7—rotating folding support structure; 71—lower bracket; 72—rotating shaft; 73—upper bracket.

### DETAILED DESCRIPTION

Some embodiments of the present disclosure are described in detail below, and optional embodiments of the present disclosure are shown in the accompanying drawings. The accompanying drawings help to well understand the description of the specification, so that a person can intuitively and vividly understand each technical feature and an overall technical solution of the present disclosure. It is noted that the accompanying drawings should not be understood as a limitation to the protection scope of the present disclosure.

The application scenarios of the stringless guitar with indicator lights and aspects of contribution to the prior art are described in detail in combination with the accompanying drawings and embodiments.

The present disclosure provides a stringless guitar for music lovers. A music lover is able to play the stringless guitar having functions of two instruments with two hands, so only one person is able to play two parts, and one person is able to play a piece of music without any partner, or only two or three music lovers are able to complete the performance of a large movement.

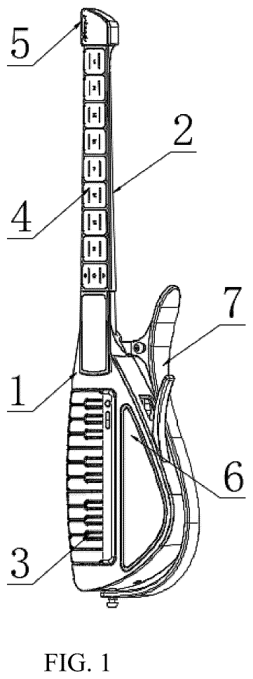

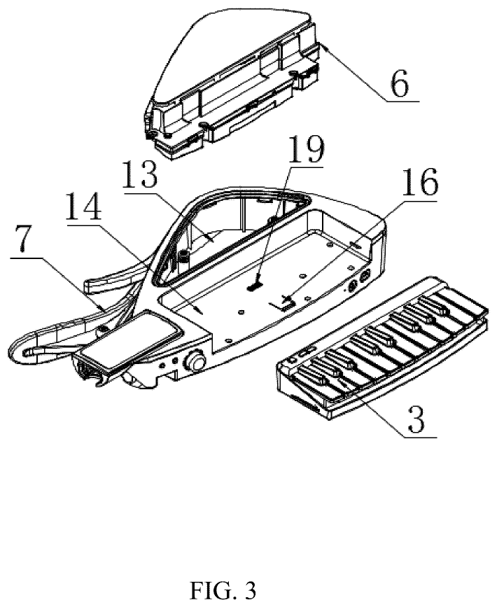

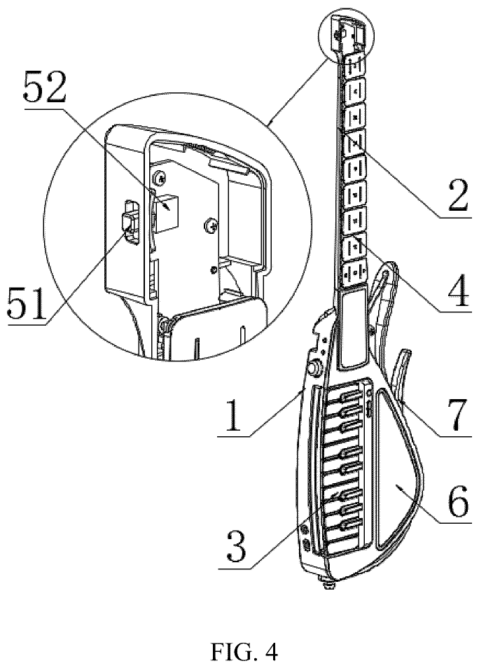

As shown in FIGS. 1-7, the present disclosure provides a stringless guitar. The stringless guitar comprises a keyboard 3, a speaker 6, a guitar body 1, a chord board 4, a guitar neck 2, a tuning device 5, a light indication system, and a rotating folding support structure 7.

The guitar body 1 is a box structure having electronic components disposed therein. The keyboard 3 is disposed in a first mounting space 14 of the guitar body 1. The speaker 6 is mounted in a second mounting space 13 of the guitar body 1. The guitar neck 2 is connected to the guitar body 1.

The chord board 4 is bar-shaped and is mounted on the guitar neck 2. The tuning device 5 is disposed on one end of the guitar neck 2 away from the guitar body 1. The tuning device 5 comprises a rocker 51 and a sensor 52. A first end of the rocker 51 is connected to the sensor 52, a second end of the rocker 51 extends out of a side surface of the guitar neck 2, and the second end of the rocker 51 is configured for a player to operate.

The light indication system comprises a first indicator light 39 and a second indicator light 43. The first indicator light 39 is configured to indicate playing positions on the keyboard 3. The second indicator light 43 is configured to indicate playing positions on the chord board 4. The rotating folding support structure 7 is mounted on the guitar body 1 and is configured to prevent the guitar body 1 from sliding off legs of the player.

The stringless guitar integrates the keyboard 3, the speaker 6, the guitar body 1, the chord board 4, the guitar neck 2, the tuning device 5, and the light indication system. The stringless guitar not only retains an appearance and an operation of a classical guitar, but also provides a new way of playing the keyboard on the stringless guitar, so that the player is allowed to enjoy a more diverse playing experience. The guitar body 1 comprises the electronic components disposed therein, and the keyboard 3 and the speaker 6 are respectively placed in different positions of the guitar body 1, making the stringless guitar compact and easy to carry. The tuning device 5 is disposed at the one end of the guitar neck 2 away from the guitar body 1. The tuning device 5 comprises the rocker 51, so the player can easily adjust the tone through the rocker 51 without interrupting the performance, which improves performance flexibility and convenience. The light indication system provides the player with a performance position indication on the keyboard 3 and the chord board 4 through the first indicator light 39 and the second indicator light 43, which reduces a probability of misoperation and enhances the accuracy and efficiency of the performance.

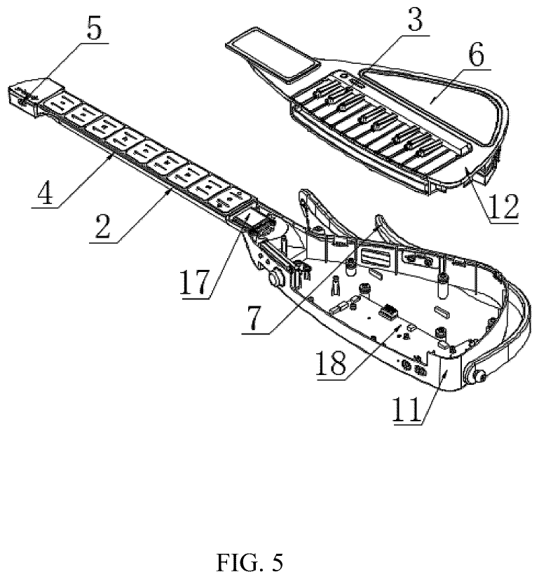

As shown in FIGS. 1 and 5, a main control board 18 is disposed in the guitar body 1. The keyboard 3, the chord board 4, the toning device 5 and the speaker 6 are connected to the main control board 18. The main control board 18 is configured to receive signals from the keyboard 3 and the chord board 4 and control the speaker 6 to output a corresponding melody.

The main control board 18 disposed in the guitar body 1 serves as a central nervous system of the stringless guitar. The main control board 18 effectively integrates signals input from the keyboard 3, the chord board 4, and the toning device 5, and is responsible for processing the signals, and finally releases the rhythm by controlling the speaker 6. The configurations not only realize the coordination between performance components (i.e., the key board and the chord board) and ensure accurate transmission of the signals, but also simplify an operation process of the player, so that the player is allowed to focus on the performance itself without worrying about playing complexity of the performance components at a technical level. Through centralized management of the main control board 18, efficiency and reliability of an overall operation of the stringless guitar are ensured, and a user experience is improved. Therefore, the player is able to enjoy high-quality music output through simple operations.

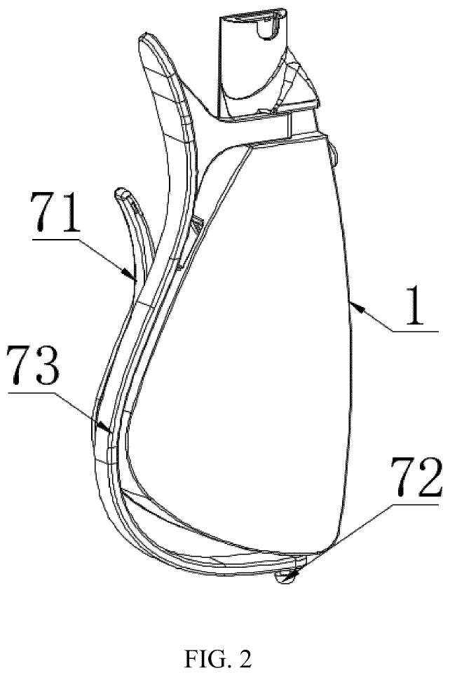

As shown in FIGS. 2-5, the guitar body 1 is a triangular box structure. The guitar body 1 comprises a first box 11 and a second box 12. A keyboard fixing piece 16 configured to fix the keyboard 3 is disposed on the second box 12. A contact sheet 19 of the main control board 18 is connected to the keyboard 3 through a through hole defined on the second box 12. An adapter 17 is disposed in one end of the guitar body 1 close to the chord board 4. The adapter 17 is connected to the main control board 18 and the chord board 4. The guitar body 1 is the triangular box structure, which not only provides the guitar body 1 a stable physical shape, but also provides a reasonable layout space for the electronic components disposed therein.

The keyboard fixing piece 16 fixes the keyboard 3 to ensure the stability and reliability of the keyboard 3 during use. The contact sheet 19 of the main control board 18 is connected to the keyboard 3 to ensure the effective transmission of the signals, so that the player is able to smoothly input the signals through the keyboard. The adapter 17 is an intermediate structure connecting the main control board 18 and the chord board 4. The adapter 17 realizes information exchange between the main control board 18 and the chord board 4. Such a design ensures close cooperation between the electronic components of the guitar body 1, making the operation of the stringless guitar efficient, and further simplifying an assembly and maintenance process.

Specifically, the keyboard 3 comprises a keyboard box 31. A clamping groove 311 is defined on a bottom portion of the keyboard box 31. The keyboard fixing piece 16 is engaged with the clamping groove 311. A control board 32 is disposed inside the keyboard box 31. The control board 32 comprises contact points 33. The contact points 33 are connected to the contact sheet 19 of the main control board 18 through an opening on the keyboard box 31, so that the control board 32 is communicated with the main control board 18. The keyboard 3 cooperates with the keyboard fixing piece 16 on the guitar body 1 to achieve fixation of the keyboard 3, which is convenient for subsequent disassembly and maintenance of the keyboard 3.

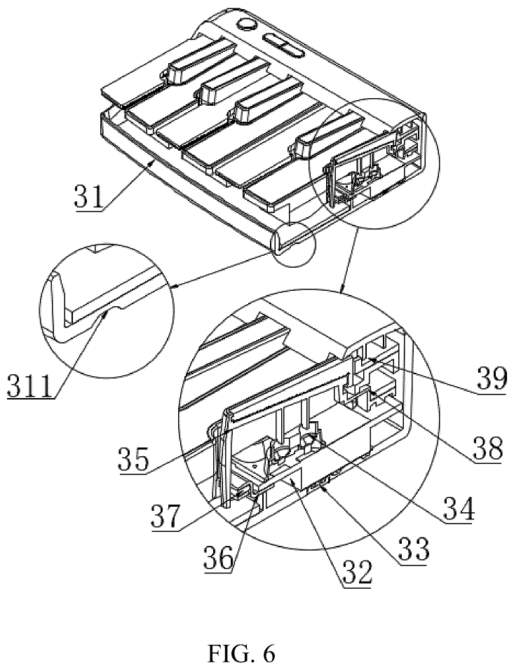

As shown in FIG. 6, a silicone pad 34 and keys 35 are disposed on the control board 32. An L-shaped light guide strip 37 is disposed on the keys 35. The L-shaped light guide strip 37 is clamped in the keys 35 through a bending rack 36. The first indicator light 39 is connected to the keyboard box 31 through a support. Light sheets are disposed on the light guide strip. When one of the keys 35 is pressed, a corresponding one of the light sheets is controlled to emit light.

The L-shaped light guide strip 37 is connected to the keys through the bending rack 36, so that the keys 35 are closely connected to the L-shaped light guide strip 37, and the L-shaped light guide strip is attached to the keys when one or more of the keys 35 are pressed. The light sheets light up to provide clear indication for the player, making it easy for the player to quickly locate corresponding keys, thereby improving the accuracy and efficiency of the performance.

Specifically, a corrugated strip pattern is disposed on a bottom portion of the L-shaped light guide strip 37. The corrugated strip pattern is disposed perpendicular to a length direction of the L-shaped light guide strip 37, and the corrugated strip pattern is optionally an arc corrugated strip pattern. When light of the light sheets is transmitted through the L-shaped light guide strip 37, and when the light reaches the corrugated strip pattern, since a refractive index of the L-shaped light guide strip 37 is greater than a refractive index of air, most of the light is totally reflected, which not only improves the brightness of the light emitted from an upper surface of the L-shaped light guide strip 37 to a certain extent, but also changes an emission angle to a certain extent, thereby increasing an observation angle of the keys. Therefore, such a design ensures that even at different viewing angles, the player is able to clearly see indicator light of the keys, and the player is well guided to play notes correctly.

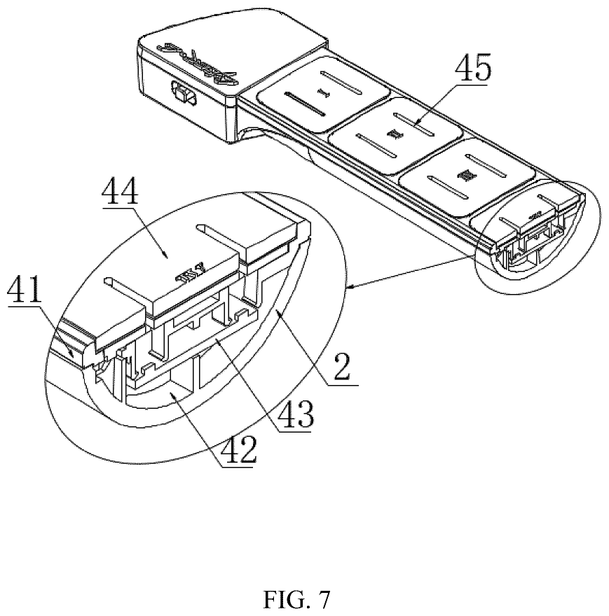

As shown in FIG. 7, the chord board 4 comprises an upper cover board 41 and a fretboard 44. The upper cover board 41 is mounted on the guitar neck 2 to jointly define a chamber 42. The second indicator light 43 and a mounting bracket are mounted in the chamber 42. The fretboard 44 is disposed on the upper cover board 41. Patches are disposed on the fretboard 44, and the patches are connected to the second indicator light 43 through the adapter 17 and the mounting bracket. The patches and the second indicator light 43 are communicated with the main control board 18 and are controlled by the main control board 18.

Specifically, such a design makes the chord board 4 of the stringless guitar not only neat in appearance, but also realizes a reasonable distribution of functional modules in the guitar neck. The chamber 42 not only provides sufficient mounting space for the second indicator light 43 and the mounting bracket, but also ensures concealment and safety of the second indicator light 43 and the mounting bracket. A connection of the fretboard 44 and the upper cover board 41 ensures that the player feels comfortable when pressing on the fretboard 44. Moreover, through connections between the patches and the second indicator light 43, the performance information is feedback in real-time, so that the player is able to perform accurately. Such a design not only enhances the performance of the stringless guitar, but also improves the user experience. Therefore, the player is allowed to play the stringless guitar as the classical guitar while enjoying the convenience brought by modern electronic technology.

Furthermore, light guide columns 45 are embedded in the fretboard 44. The light guide columns 45 are connected to the second indicator light 43. Light strips are disposed on the second indicator light 43. The light strips are one-to-one corresponding to the light guide columns 45.

Such a design allows a corresponding one of the light strips to light up when the player presses on a specific light guide column, and the light is transmitted to the fretboard through the specific light guide column 45, providing clear indication for the player. Therefore, not only is the player able to quickly find a correct playing position and reduce playing errors, but also the performance efficiency is improved to a certain extent. Especially in the performance of complex music, the indication provided by the light guide columns is particularly important. With the guidance of the light, the player can focus more on the expressiveness of the music instead of being distracted by finding a correct finger position.

As shown in FIG. 2, the rotating folding support structure 7 comprises a lower bracket 71, an upper bracket 73, and a rotating shaft 72. The lower bracket 71 is fixed to a middle portion of the guitar body 1. The lower bracket 71 is an arc-shaped structure and is configured to support on the legs of the player. The rotating shaft 72 is mounted on a bottom portion of the guitar body 1. Two ends of the upper bracket 73 are respectively rotatably connected to the guitar body 1 and the rotating shaft 72.

Such a design not only ensures the stability and comfort of the stringless guitar when playing, but also improves the portability of the stringless guitar. The lower bracket 71 allows the stringless guitar to be placed firmly on the legs of the player, thereby effectively preventing the stringless guitar from slipping off. Meanwhile, the upper bracket 73 enables the stringless guitar to be folded and stored when not needed, making the stringless guitar easy to carry and store. Through the rotating folding support structure, not only the playing experience is improved, but also the stringless guitar is suitable for use in different occasions.

Technical features of the above-mentioned embodiments can be combined arbitrarily. For the sake of brevity, all possible combinations of the technical features in the above-mentioned embodiments are not described. However, as long as there is no contradiction between the combinations of these technical features, the combinations should be considered to be within the scope of the specification.

The above-mentioned embodiments only represent some embodiments of the present disclosure. The descriptions thereof are specific and detailed, but should not be construed as a limitation of the scope of the present disclosure. It should be pointed out that for those of ordinary skill in the art, without departing from the concept of the present disclosure, modifications and improvements can be made. The modifications and the improvements belong to the protection scope of the present disclosure. Therefore, the protection scope of the present disclosure should be subject to the attached claims.

1. A stringless guitar, comprising:
a guitar body;
a guitar neck;
a keyboard;
a chord board;
a tuning device;
a light indication system;
a speaker; and
a rotating folding support structure;
wherein the guitar body is a box structure, the keyboard is disposed in a first mounting space of the guitar body, the speaker is disposed in a second mounting space of the guitar body, and the guitar neck is connected to the guitar body;
wherein the chord board is bar-shaped and is mounted on the guitar neck, the tuning device is disposed on one end of the guitar neck away from the guitar body, the tuning device comprises a rocker and a sensor, a first end of the rocker is connected to the sensor, a second end of the rocker extends out of a side surface of the guitar neck, and the second end of the rocker is configured for a player to operate;
wherein the light indication system comprises a first indicator light and a second indicator light, the first indicator light is configured to indicate playing positions on the keyboard, and the second indicator light is configured to indicate playing positions on the chord board;
wherein the rotating folding support structure is mounted on the guitar body and is configured to prevent the guitar body from sliding off legs of the player.

2. The stringless guitar according to claim 1, wherein a main control board is disposed in the guitar body;
wherein the keyboard, the chord board, the toning device, and the speaker are connected to the main control board, and the main control board is configured to receive signals from the keyboard and the chord board and control the speaker to output a corresponding melody.

3. The stringless guitar according to claim 2, wherein the guitar body is a triangular box structure, the guitar body comprises a first box and a second box, a keyboard fixing piece configured to fix the keyboard is disposed on the second box, a contact sheet of the main control board is connected to the keyboard through a through hole defined on the second box, an adapter is disposed in one end of the guitar body close to the chord board, and the adapter is connected to the main control board and the chord board.

4. The stringless guitar according to claim 3, wherein the keyboard comprises a keyboard box, a clamping groove is defined on a bottom portion of the keyboard box, and the keyboard fixing piece is engaged with the clamping groove;
wherein a control board is disposed inside the keyboard box, the control board comprises contact points, the contact points are connected to the contact sheet of the main control board through an opening on the keyboard box, so that the control board is communicated with the main control board.

5. The stringless guitar according to claim 4, wherein a silicone pad and keys are disposed on the control board, an L-shaped light guide strip is disposed on the keys, the L-shaped light guide strip is clamped in the keys through a bending rack, the first indicator light is connected to the keyboard box through a support, light sheets are disposed on the light guide strip, and when one of the keys is pressed, a corresponding one of the light sheets is controlled to emit light.

6. The stringless guitar according to claim 5, wherein the chord board comprises an upper cover board and a fretboard, the upper cover board is mounted on the guitar neck to jointly define a chamber, the second indicator light and a mounting bracket are mounted in the chamber, and the fretboard is disposed on the upper cover board, patches are disposed on the fretboard, and the patches are connected to the second indicator light through the adapter and the mounting bracket, and the patches and the second indicator light are communicated with the main control board and are controlled by the main control board.

7. The stringless guitar according to claim 6, wherein light guide columns are embedded in the fretboard, the light guide columns are connected to the second indicator light, light strips are disposed on the second indicator light, and the light strips are one-to-one corresponding to the light guide columns.

8. The stringless guitar according to claim 1, wherein the rotating folding support structure comprises a lower bracket, an upper bracket, and a rotating shaft; wherein the lower bracket is fixed to a middle portion of the guitar body, the lower bracket is an arc-shaped structure and is configured to support on the legs of the player, the rotating shaft is mounted on a bottom portion of the guitar body, and two ends of the upper bracket are respectively rotatably connected to the guitar body and the rotating shaft.
